(19) United States
(12) Patent Application Publication
(10) Pub. No.: US 2006/0177073 A1
(43) Pub. Date: Aug. 10, 2006

(54) Self-orienting audio system

(76) Inventors: Emad S. Isaac, Woodridge, IL (US); Jay D. O'Connor, Chicago, IL (US)

Correspondence Address: MOTOROLA, INC., 1303 EAST ALGONQUIN ROAD, IL01/3RD, SCHAUMBURG, IL, 60196, US

(21) Appl. No.: 11/054,731

(22) Filed: Feb. 10, 2005

(51) Int. Cl. H04R 29/00; H04R 3/00

(52) U.S. Cl. 381/59; 381/58; 381/96

(57) ABSTRACT

A self-orienting audio system includes a master controller and a plurality of loudspeaker modules. Each module includes an audio input and a controller coupled to the audio input and loudspeaker. The master controller communicates with the plurality of loudspeaker modules. The master controller can determine a distance to each of the loudspeaker modules and assign an audio channel to each of the loudspeaker modules depending upon that distance. The master controller can be incorporated into one of the modules. Distance to each module can be determined using signal delay or signal magnitude.

### FIELD OF THE INVENTION

The present invention relates generally to audio sound systems. More specifically, the invention relates to a technique for orienting speaker locations in an audio system.

### BACKGROUND OF THE DISCLOSURE

With the growth of multi-media and multi-channel audio systems for use in the car and home, it is becoming increasingly difficult and expensive for consumers to add such systems in these environments. For example, a consumer who might want to add wired rear channel loudspeakers to their cars would need to remove the flooring or paneling to run wires to these loudspeakers, not to mention the difficulty in cutting holes into door panels or trunk decks to install loudspeakers. The same problem of running more wires would also occur in the home environment. In addition, the chance to make a wiring mistake increases with multiple channels.

One solution is to provide wireless loudspeakers that can be placed anywhere in the environment. Such wireless (e.g. WiFi, etc.) audio systems are a reality in the home and are becoming a reality in the car. However, a consumer still has the difficulty of manually configuring all these speakers properly. In addition, any changes to the audio system would require the consumer to again reconfigure all of the speakers manually.

What is needed is an easy way for a consumer to place audio devices in an environment. In particular, it would be beneficial if a system could automatically self-orient relative orientation of loudspeakers within an audio environment.

### BRIEF DESCRIPTION OF THE DRAWINGS

The features of the present invention, which are believed to be novel, are set forth with particularity in the appended claims. The invention, together with further objects and advantages thereof, may best be understood by making reference to the following description, taken in conjunction with the accompanying drawings, in the several figures of which like reference numerals identify identical elements, wherein:

FIG. 1 shows a plan view of a system, in accordance with the present invention; and

FIG. 2 shows a block diagram of a loudspeaker module in the system of FIG. 1.

### DETAILED DESCRIPTION OF EMBODIMENTS OF THE INVENTION

The present invention describes an easy way for a consumer to place audio devices in an environment. In particular, a system of loudspeaker modules is described that can automatically self-orient relative orientation of loudspeakers within an audio environment. Specifically, the present invention provides dynamic assignment of a plurality of devices (i.e. speaker) located in reference to an architecture or layout (i.e. front/back, left/right speakers) of a vehicle or home environment.

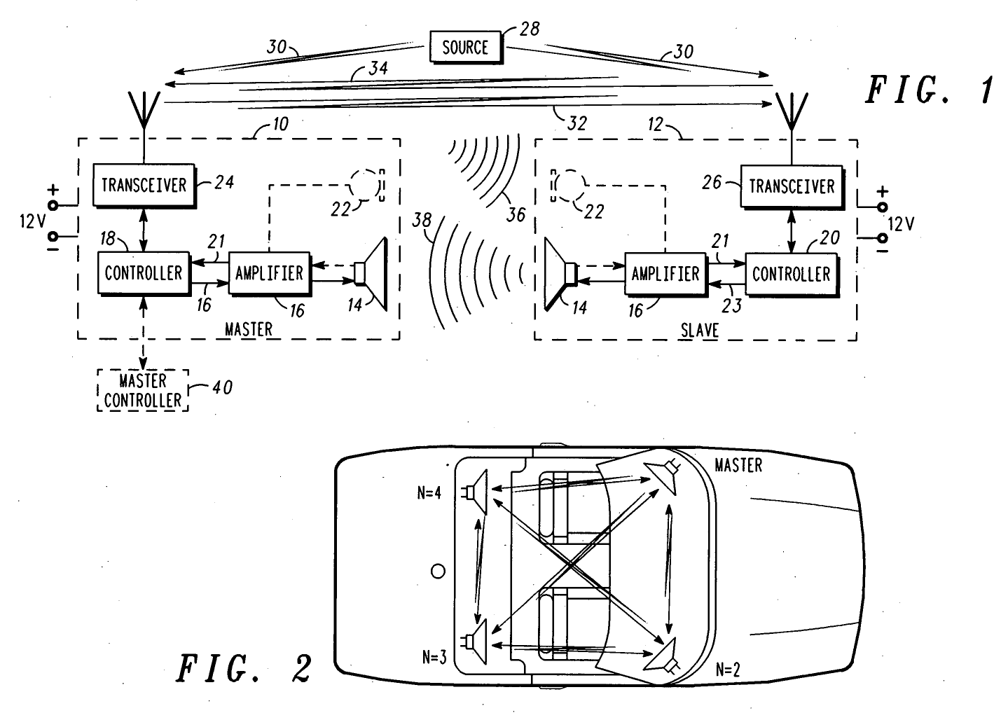

Referring to FIG. 1, a wireless embodiment of the present invention is shown. In it simplest form, the present invention is a loudspeaker module, such as one of the wireless loudspeaker modules shown (10, 12). The loudspeaker module can be placed anywhere a user desires in an environment with nothing more than a power hook up. In the examples herein, a vehicle environment is described, wherein twelve volt power from the vehicle is used to power the modules as shown. However, other available vehicular power systems can be used, including batteries installed in the module. In a home environment, 110V power can be supplied with suitable regulation in or outside of the module, as needed.

The loudspeaker module includes a loudspeaker 14 driven by an amplifier stage 16. Audio signals 23 to the amplifier stage 16 are supplied by a controller (18, 20). An audio input 21 is also coupled from the amplifier stage 16 back to the controller 18, 20. The amplifier stage 16 contains circuitry to for processing signals to and from the controller. Where audio fidelity is not an issue, the loudspeaker itself 14 can be used to provide the audio input. Otherwise, a separate microphone 22 can be used to supply the audio input.

With the additions of transceivers 24, 26, under control of their respective controllers 18, 20, a plurality of modules 10, 12 can be wirelessly linked together in a local area network (LAN) to receive signals from an audio source 28 (e.g. vehicle radio, head unit, or network access device). Such LAN technology already exists in Bluetooth™ systems, for example. However, other wireless local (and wide area) network systems can be used equally well. In a typical LAN system, any one of the modules 10 can act as a master module, to be the gateway for all calibration logic for directing any other module 12. In this way, only a single module configuration need be stocked by a retailer. In this case, the first module powered on can act as the master, according to Bluetooth™ protocols, for example, and each module 12 brought into the system thereafter is assigned a LAN slave address for individually addressed communication with the master module 10. Alternatively, one module can be dedicated as the master module 10, which can be positioned and manually calibrated (and from which additional modules would orient thereto). Being the master module can entail special circuitry dedicated to that one module, or a specified registration process to define that module 10 as master, in accordance with that LAN's protocols. For example, master module 10 can be chosen to respond to an external master controller 40, which in turn is used to control other modules 12 in the LAN. Preferably, the controller 18 can be programmed to be the master controller itself, negating the need for special circuitry (i.e. controller 40). Optionally, the audio source 28 in the vehicle can act as the master controller.

In operation, a slave controller 20 is operable to communicate with and respond to a master controller (18, 40 or 28). The master controller can communicate with each slave controller through its LAN slave address, and can assign that slave controller 20 to play a specified audio channel from an audio source 28. For example, in a four channel audio system (i.e. left front, right front, left rear, right rear), an audio source can broadcast four audio channels on the LAN, each channel coded with a specific address. The master module 10 (e.g. the first module powered up) can be assigned with the address to play one channel (e.g. left front). The master module 10 can then determine a distance to each slave module 12 and assign each an audio channel to receive from the source 28 and play.

Referring to FIG. 2, a system is shown wherein a master controller can use distance to orient the audio channels in a vehicular environment, for example. As before, the master module is assigned the left front audio channel. Under direction of the master controller the slave controller of each slave module (N=2, 3, 4) can provide a signal to the master controller, which uses the signal to determine a distance therebetween. The module that is determined to be the shortest distance (N=2) from the master is assigned to play the audio signal coded as the right front channel. The module that is the next longest distance (N=4) from the master is assigned to play the audio signal coded as the left rear channel. The module that is the next longest distance (N=3) from the master is assigned to play the audio signal coded as the right rear channel. In this way, each slave controller responds to commands from the master controller assigning a specific address to receive the defined audio channel, depending upon their distance, and play audio therefrom on their respective loudspeaker. Distance calibration can be manually activated or can operate at specified intervals to orient any devices entering or leaving an active system.

Returning to FIG. 1, there are many ways for the master module 10 to determine the distance to each slave module 12. These ways can be used alone or in combination. In each case, the master module 10 sends a signal 32 to each slave module 12 directing it to emit a return signal to the master module 10 for determining a distance therebetween. Additionally, a user could manually designate a wireless device (i.e. specify its orientation) to cover potential instances where a user may want to co-locate speakers or devices into a one location without confusing the system. The return signal can be a radio frequency signal 34 from the slave module's transceiver 26 or an audio signal 38 from the slave module's loudspeaker 14. Distance can be determined by a time delay to receive the return signal (which is problematic for RF signals) or preferably by determining a relative signal strength of the return signal from each module. Relative signal strength is more preferable as signal strength changes as the square of the distance, which can be better discriminated than a linear time delay. However, this requires calibration of modules to emit the same signal strength.

In the case of determine distance by time delay, the master controller can send an RF signal 32 to each slave module 12 in turn, directing each to send an audio chirp 38 back to the master module 10. Assuming instantaneous RF transmission, the total delay multiplied by the speed of sound will give the distance. In the case of determining distance by signal strength, the master controller can send an RF signal 32 to each slave module 12 in turn, directing each to send either or both of an audio signal 38 and/or RF signal back to the master module 10 to detect their respective strengths. A signal strength calibration algorithm can be located in each module controller, or can be downloaded or pushed to each module via a central control point (i.e. radio, head unit, master controller, or master module controller).

The configuration of the present invention also lends itself to other audio improvements. For example, the loudspeaker 14 of each module can be equalized for a desired frequency response. Equalization can be performed by the master controller or by each device itself given an optional microphone 22. For example, the master module can direct each slave module, in turn, to play a range of audio test frequencies by their respective loudspeaker for monitoring by the audio input of the master module. The master module can then determine equalization parameters for that slave module which are transmitted to the slave controller for equalization of that loudspeaker for a desired frequency response. Alternatively, each module can itself play a range of audio test frequencies by their respective loudspeaker for self-monitoring by that module's audio input, wherein that controller can self-equalize its loudspeaker. Audio pulses can also emitted and detected with a Fast Fourier Transform to determine frequency response for equalization.

Another improvement is the sensing of ambient environment for the purposes of amplitude or characteristics adjustment, wherein a controller is operable to monitor an audio environment through its audio input or loudspeaker, and then adjust an amplitude and/or frequency response of the loudspeaker module to compensate for the audio environment. For example, a brief period can be injected in an audio stream to allow for a module to record ambient/residual sounds. As before, this can be performed by the master module or by each slave module. Such adjustment capability can be used to instruct a specific device(s) to increase or decrease volume or tone characteristics, in response to sudden changes in environment (e.g. open window, wind noise, traffic noises, etc.).

Further, the system of the present invention can be used to reduce detected rattle and reverberation caused by the environment. For example, heavy bass can sometimes rattle loose fittings, shake inside panels or doors, etc. causing an unpleasant noise for passengers. The present invention can mitigate these problems by having each the master module or each slave module detect these ambient conditions and correct them as needed. For example, a module can apply a notch filter at a particular frequency that causes an annoying resonance in the environment.

In a further embodiment, a secondary or subset system can be incorporated into the system of the present invention. For example, a master controller can assume (automatic or when so commanded) control of its peers in a given system. In other words, a master can establish command and control for a given set, while a secondary designate can act as a master for a secondary or subset system (e.g. main set is the car audio speakers, and secondary set is a PDA, cell phone speakers, Bluetooth™ ear piece, etc. that also are operable on a LAN). In this way, a user can use a cell phone Bluetooth™ ear piece as a speaker for personal audio in the subset while also using heavy bass from rear speakers in the main set to provide optimal control for a personal media experience.

With growth of wireless devices such as car speakers, the present invention advantageously allows a consumer to place their audio devices anywhere they want to suit their personal needs. The present invention will orient these audio devices so as to respond properly to balance and fade adjustments. In addition, the system provides ease of use in adding or removing component devices to system. In this way, a non-vehicle owner can bring in their own devices for a true customization experience. The modular nature of the present invention allows audio arbitration that bypassing the logic of the built in audio systems (e.g. radio, head unit, etc.) of the vehicle, which provides a consumer the freedom to change the audio environment at will without the need to change an installed vehicle system.

While the present invention has been particularly shown and described with reference to particular embodiments thereof, it will be understood by those skilled in the art that various changes may be made and equivalents substituted for elements thereof without departing from the broad scope of the invention. In addition, many modifications may be made to adapt a particular situation or material to the teachings of the invention without departing from the essential scope thereof. Therefore, it is intended that the invention not be limited to the particular embodiments disclosed herein, but that the invention will include all embodiments falling within the scope of the appended claims.

What is claimed is:

1. A self-orienting loudspeaker module comprising:
a loudspeaker;
an audio input; and
a controller coupled to the audio input and loudspeaker, the controller is operable to communicate with and respond to a master controller, wherein under direction of the master controller the controller can provide a signal to the master controller, which uses the signal to determine a distance therebetween, and respond to commands from the master controller to receive an audio channel, assigned by the master controller depending upon that distance, and play audio therefrom on the loudspeaker.

2. The module of claim 1, wherein the audio input is a microphone.

3. The module of claim 1, wherein the audio input is the loudspeaker itself.

4. The module of claim 1, wherein the modules communicate with the master controller using a wireless radio frequency link that is individually addressable for the module, and wherein the distance to each module is determined by the amount of delay for a signal to reach the master controller from a particular module.

5. The module of claim 4, wherein the signal is one of the group of an audio signal and a radio frequency signal.

6. The module of claim 1, wherein the controller is operable to play a range of audio test frequencies by the loudspeaker for monitoring by the audio input to equalize the loudspeaker for a desired frequency response.

7. The system of claim 1, wherein the controller is operable to monitor an audio environment through the audio input, wherein the controller can adjust a frequency response of the loudspeaker module to compensate for the audio environment.

8. A self-orienting audio system comprising:
a plurality of loudspeaker modules, each module including an audio input, a controller coupled to the audio input and loudspeaker, and a transceiver coupled to the controller; and
a master controller operable to communicate with the plurality of loudspeaker modules, the master controller operable to determine a distance to each of the loudspeaker modules and assign an audio channel to each of the loudspeaker modules depending upon that distance.

9. The system of claim 8, wherein the audio input is a microphone.

10. The system of claim 8, wherein the audio input is the loudspeaker itself.

11. The system of claim 8, wherein the distance to each module is determined in the master controller by a magnitude of a signal received from a particular module.

12. The system of claim 8, wherein the modules communicate with the master controller using a wireless radio frequency link that is individually addressable for each module, and wherein the distance to each module is determined in the master controller by the amount of delay for a signal to reach the master controller from a particular module.

13. The system of claim 12, wherein the signal is one of the group of an audio signal and a radio frequency signal.

14. The system of claim 8, wherein the master controller is incorporated into one of the plurality of loudspeaker modules.

15. The system of claim 14, wherein the master controller is operable to direct the controller of each loudspeaker module to play a range of audio test frequencies for monitoring by the master controller, whereafter the master controller directs the controller of the associated loudspeaker module to equalize the loudspeaker for a desired frequency response.

16. The system of claim 14, wherein an audio input of the master controller is operable to monitor an audio environment of the system, wherein the master controller can adjust a frequency response of the plurality of loudspeaker modules to compensate for the audio environment.

17. The system of claim 8, wherein an audio input of a loudspeaker module is operable to monitor an audio environment of the system, wherein the associated controller can adjust a frequency response of its associated loudspeaker to compensate for the audio environment.

18. The system of claim 8, wherein the master controller communicates with the modules and determines a distance to each module upon powering up of the system, so as to dynamically assign an audio channel to each module.

19. The system of claim 8, further comprising a secondary master controller that controls a subset of the loudspeaker modules.

20. A self-orienting wireless audio system comprising:
a plurality of loudspeaker modules, each module including an audio input and a controller coupled to the audio input and loudspeaker; and
a master controller including within one of the plurality of loudspeaker modules, the master controller operable to communicate with the other loudspeaker modules using a wireless radio frequency link that is individually addressable for each module wherein the controllers of the other modules are slaved under the master controller, the master controller operable to determine a distance to each of the other loudspeaker modules and assign an audio channel to each of the other loudspeaker modules depending upon that distance.
